(19) United States
(12) Patent Application Publication
(10) Pub. No.: US 2005/0281945 A1
(43) Pub. Date: Dec. 22, 2005

(54) Process for fully infiltrating porous fiber preforms with ceramic particulate

(75) Inventors: Roger Lee Ken Matsumoto, Newark, DE (US); Daniel M. Domanski, Kennett Square, PA (US)

Correspondence Address: NIXON & VANDERHYE P.C., 901 NORTH GLEBE ROAD, 11TH FLOOR, ARLINGTON, VA, 22203, US

(73) Assignee: General Electric Company, Schenectady, NY (US)

(21) Appl. No.: 10/870,911

(22) Filed: Jun. 21, 2004

(51) Int. Cl. B05D 3/02

(52) U.S. Cl. 427/180

(57) ABSTRACT

A method of infiltrating a porous fiber preform with ceramic particulates includes (a) flowing a slurry having a first predetermined percent solids by weight of ceramic particulates through the porous fiber preform; (b) increasing the percent solids by weight of ceramic particulates in said slurry to a second predetermined percent and otherwise repeating step (a); and (c) increasing the percent solids by weight of ceramic particulates in the slurry to a third predetermined percent solids by weight of ceramic particulates and otherwise repeating step (a).

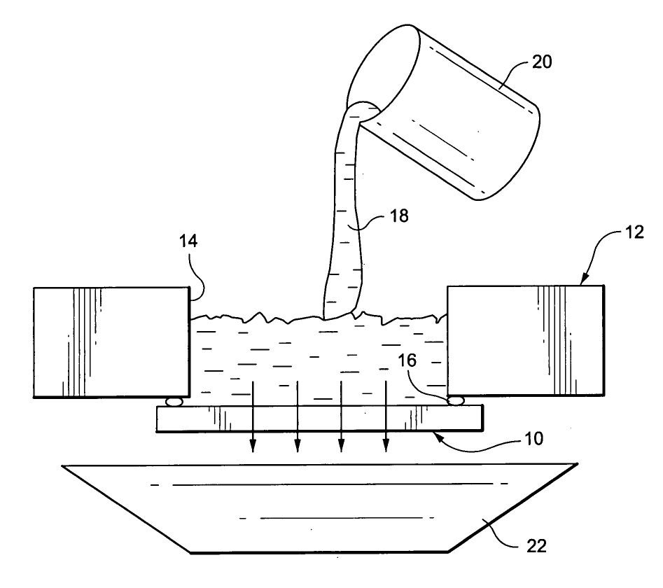

### BACKGROUND OF THE INVENTION

This invention relates to the manufacture of machine components and particularly to the manufacture of ceramic matrix composite (CMC) components.

In order to increase efficiency and performance in gas turbine engines, engine combustors operate at higher temperatures that sometimes surpass the limits of the material comprising the components in the combustor section of the engine. As combustor operating temperatures have increased, ceramic matrix composites (CMC's) have been developed as substitutes for high temperature metal alloys. The CMC's provide an improved temperature advantage over metals, making them the material of choice when higher operating temperatures are desired. Typically, CMC's comprise micron-sized reinforcement fibers (or particulates) of one composition that are dispensed or embedded in continuous ceramic matrices of the same or different composition. For example, some well known CMC's include carbon-carbon (C—C), carbon-silicon carbide (C—SiC) and silicon carbide-silicon carbide (SiC—SiC) composites.

CMC's may be formed by an initial chemical vapor infiltration (CVI), polymer impregnation pyrolysis (PIP) or melt infiltration (MI) process that brings the preform to a partially densified state.

Further infiltration of porous fiber preforms with ceramic particulates, especially in connection with SiC-Sic composites, has been accomplished via static pressure or vacuum processes that force a ceramic slurry into the pores of the preform. Such methods have resulted, however, in large, isolated and unfilled pores, typically along the centerline of the thickness of the preform. These unfilled regions persist through all subsequent process steps and thus result in inferior properties for the finished composite body.

### BRIEF DESCRIPTION OF THE INVENTION

The present invention utilizes a dynamic ceramic slurry filling or infiltration as a second step in the CMC manufacturing process, in which the concentration of the ceramic solids (particulates or microfibers) commences at a low level and increases over time. In addition, the introduction of the slurry is unidirectional, so that the slurry is free to flow through the component or preform until all open pores are filled.

In an exemplary embodiment, the preform is fixtured below a center opening in a rubber container or plate. Thus, the rubber container or plate acts as a reservoir from which the ceramic slurry is supplied to the preform. Initially, a slurry containing about 38% solids (for example, SiC microfibers or particulates) by weight is poured into the reservoir. This initial slurry is very thin and flows out of the reservoir and through the preform quickly. The reservoir is then filled several additional times to insure that the preform is completely wetted by the slurry. Subsequently, a slurry of the same composition but with higher solids loading (about 50% by weight) is introduced into the container. This slurry composition takes longer to flow through the preform. Finally, the solids content of the slurry is increased to about 76% by weight. Once the liquid level of this high-solids content slurry in the reservoir stabilizes, no further slurry is added.

This graduated process results in complete infiltration of the preform by the slurry, with the substantial elimination of centerline pores found in prior infiltration processes.

Accordingly, in its broadest aspects, the invention relates to a method of infiltrating a porous fiber, preform with ceramic particulates comprising: (a) flowing a slurry having a first predetermined percent solids by weight of ceramic particulates through the porous fiber preform; (b) increasing the percent solids by weight of ceramic particulates in said slurry to a second predetermined percent and otherwise repeating step (a); and (c) increasing the percent solids by weight of ceramic particulates in the slurry to a third predetermined percent solids by weight of ceramic particulates and otherwise repeating step (a).

In another aspect, the invention relates to a method of infiltrating a porous fiber preform with ceramic particulates comprising: (a) flowing a slurry having a first predetermined percent solids by weight of ceramic particulates through the porous fiber preform; (b) increasing the percent solids by weight of ceramic particulates in the slurry to a second predetermined percent and otherwise repeating step (a); and (c) increasing the percent solids by weight of ceramic particulates in the slurry to a third predetermined percent solids by weight of ceramic particulates and otherwise repeating step (a); wherein the porous fiber preform comprises SiC fiber cloth and the particulates comprise SiC.

The invention will now be described in connection with the single drawing identified below.

### BRIEF DESCRIPTION OF THE DRAWINGS

The single FIGURE illustrates schematically a porous fiber preform infiltration process in accordance with an exemplary embodiment of the invention.

### DETAILED DESCRIPTION OF THE INVENTION

With reference to the single drawing FIGURE, a preform 10 is located and arranged below a rubber container or plate 12. The preform 10 is centered on an opening 14 formed in the container 12 and held fixed in that position by any suitable mechanical fixture means (not shown). The preform 10 may be sealed relative to the container 12 by means of a conventional O-ring type seal 16 or by any other suitable seal.

A ceramic slurry 18, comprised of SiC particulates and an evaporable liquid, is poured from a drum or other structure 20 into the opening 14 in the container 12 and serves as a reservoir for supplying the slurry to the preform. A catch basin 22 is located in spaced relationship below the preform 10 in order to catch the excess slurry passing through the preform.

In one example, the continuous ceramic matrix comprises a preform 10 made using several thicknesses of SiC fiber cloth, consolidated initially by a conventional CVI process. The preform may have a size of 6 in.×9 in.×0.188 in. thick. The opening 14 in the container 12 may have a 3 in.×6 in. dimension, while the container may be approximately 1 in. thick. The dimensions may, of course, vary with the CMC application.

In order to embed the reinforcement fibers or particulates into the SiC matrix (i.e., the cloth preform 10) to fully densify the CMC, the slurry 18 is poured into the container (reservoir) 12 via opening 14 with a solids content of about 38% by weight. The solids composition may be C or SiC, but carbon CMC's are typically fully densified in the initial CVI procedure. The invention here may be more advantageously used in connection with SiC—SiC composites. In any event, because this slurry is very thin, it passes through the preform 10 and into the catch basin 22 fairly quickly. The reservoir 12 is then filled several times with the same concentration slurry in order to insure that the preform 10 is completely wetted by the slurry 18.

Subsequently, a slurry 18 of the same composition but with a higher solids content of about 50% by weight is poured into the container or reservoir 12. Because the thickness of the slurry 18 has been increased by approximately 12%, the slurry takes longer to flow through the preform 10 and into the catch basin 22. As a final step, the solids content of the slurry 18 is increased to about 76% by weight, and once the slurry level within the reservoir 12 is stabilized, no further slurry is added.

The unidirectional flow of the slurry 18 through the preform 10, combined with the increasing solids content, eliminates the unfilled pores typically found in preforms manufactured in accordance with the current static processes. After the slurry-pouring process as described above is completed, residual and/or added silicon on the surface of the preform is heated to about 2600° F. to melt into any remaining unfilled pores in the preform.

In a test case, microscopic analysis of the cross-section of the dried SiC—SiC component part showed full infiltration of the part by the slurry, and there was a virtual absence of centerline pores. Certain isolated pores that did occur could be attributed to the fact that the slurry was not de-aired prior to use. It is expected that performing the same test with slurry subjected to the standard de-airing process will result in the complete elimination of unfilled pores.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

1. A method of infiltrating a porous fiber preform with ceramic particulates comprising:
(a) flowing a slurry having a first predetermined percent solids by weight of ceramic particulates through the porous fiber preform;
(b) increasing said percent solids by weight of ceramic particulates in said slurry to a second predetermined percent and otherwise repeating step (a); and
(c) increasing said percent solids by weight of ceramic particulates in said slurry to a third predetermined percent solids by weight of ceramic particulates and otherwise repeating step (a).

2. The method of claim 1 wherein said first predetermined percent is about 38%.

3. The method of claim 1 wherein said second predetermined percent is about 50%.

4. The method of claim 1 wherein said third predetermined percent is about 76%.

5. The method of claim 1 wherein said first predetermined percent is about 38%; said second predetermined percent is about 50%; and said third predetermined percent is about 76%.

6. The method of claim 1 wherein said porous fiber preform comprises SiC fiber cloth.

7. The method of claim 1 wherein said ceramic particulates comprise SiC.

8. The method of claim 1 wherein said porous fiber preform has a thickness of less than 0.2 inches.

9. The method of claim 6 wherein said porous fiber preform has a thickness of less than 0.2 inches.

10. The method of claim 1 wherein step (a) is carried out at least twice prior to step (b).

11. The method of claim 1 wherein the porous fiber preform is located below a supply reservoir having a center opening therein, and above a catch basin.

12. A method of infiltrating pores of a fiber preform with ceramic particulates comprising:
(a) flowing a slurry having a first predetermined percent solids by weight of ceramic particulates through the porous fiber preform;
(b) increasing said percent solids by weight of ceramic particulates in said slurry to a second predetermined percent and otherwise repeating step (a); and
(c) increasing said percent solids by weight of ceramic particulates in said slurry to a third predetermined percent solids by weight of ceramic particulates and otherwise repeating step (a);
wherein said porous fiber preform comprises SiC fiber cloth and said particulates comprise SiC.

13. The method of claim 12 wherein the porous fiber preform is located below a supply reservoir having a center opening therein, and above a catch basin.

14. The method of claim 12 wherein said first predetermined percent is about 38%; said second predetermined percent is about 50%; and said third predetermined percent is about 76%.

15. The method of claim 11 wherein, after step (c), silicon is melted into any remaining unfilled pores of the preform.
